(19) United States
(12) Patent Application Publication
(10) Pub. No.: US 2012/0288692 A1
(43) Pub. Date: Nov. 15, 2012

(54) RENEWABLY SOURCED FILMS AND METHODS OF FORMING SAME

(76) Inventors: Norman Scott Broyles, Hamilton, OH (US); Pier-Lerenzo Caruso, Frankfurt am Main (DE)

(21) Appl. No.: 13/445,745

(22) Filed: Apr. 12, 2012

Related U.S. Application Data
(60) Provisional application No. 61/474,478, filed on Apr. 12, 2011.

(51) Int. Cl. B32B 7/02; B32B 27/28

(52) U.S. Cl. 428/213; 428/220

(57) ABSTRACT

Mono- and multi-layer films having film layers at least partially formed from a polymer (A) wherein polymer (A) is at least partially derived from a renewable resource such that the mono- or multi-layer film has a bio-based content of about 10% to about 100% using ASTM D6866-10, method B. Methods of forming high biocontent mono- and multi-layer films are also provided.

### CROSS REFERENCE TO RELATED APPLICATIONS

This application claims the benefit of U.S. patent application Ser. No. 13/084,630, filed Apr. 12, 2011; and U.S. Provisional Patent Application Ser. No. 61/474,478, filed Apr. 12, 2011.

### FIELD OF THE INVENTION

The present disclosure generally relates to mono and multi-layer films having a bio-based content of about 10% to about 100% using ASTM D6866-10, method B.

### BACKGROUND OF THE INVENTION

Many products today require highly engineered components and yet, at the same time, these products are required to be limited use or disposable items. By limited use or disposable, it is meant that the product and/or component is used only a small number of times or possibly only once before being discarded. Examples of such products include, but are not limited to, personal care absorbent articles such as diapers, training pants, incontinence garments, sanitary napkins, bandages, wipes, tissue-towel paper products, and the like, as well as materials used for the packaging of products. These types of products can and do utilize films. When films are used in limited use and/or disposable products, the impetus for maximizing engineered properties while reducing cost is extremely high.

Most of the materials used in current commercial mono and multi-layer films, especially those utilized in packaging applications, are derived from non-renewable resources, such as petroleum. Typically, the components of mono and multi-layer films are made from polyolefins, such as polyethylene and polypropylene, and polyethylene terephthalate. These polymers are derived from monomers, such as ethylene, propylene, and terephalic acid, which are typically obtained directly from petroleum and/or natural gas via cracking and refining processes.

The price and availability of the petroleum/natural gas feedstock ultimately has a significant impact on the price of films which utilize materials derived from petroleum. As the worldwide price of petroleum escalates, so does the price of such films.

Furthermore, many consumers display an aversion to purchasing products that are derived from petrochemicals. In some instances, consumers are hesitant to purchase products made from limited non-renewable resources such as petroleum, natural gas, and coal. Other consumers may have adverse perceptions about products derived from petrochemicals being “unnatural” or not environmentally friendly.

Accordingly, it would be desirable to provide a mono or multi-layer film which comprises at least one polymer at least partially derived from renewable resources, where the at least one polymer has specific performance characteristics making the polymer particularly useful in the mono and multi-layer films.

### SUMMARY OF THE INVENTION

The present disclosure generally relates to mono- and multi-layer polymeric films having bio-based content and methods of forming the same.

In accordance with a first aspect, a mono-layer film is comprised of a material or mixture of materials having a total bio-based content of about 10% to about 100% using ASTM D6866-10, method B. The film layer has a thickness of from about 1 μm to about 750 μm and is at least partially formed from a polymer (A). In one embodiment, the film layer has a thickness of from about 1 μm to about 200 μm. The film layer comprises from about 75% to about 99% by weight of a polymer (A). The polymer (A) comprises at least one or possibly more of a low density polyethylene (LDPE), a polar copolymer of polyethylene such as ethylene vinyl acetate (EVA), a linear low density polyethylene (LLDPE), a high density homopolyethylene/high density polyethylene copolymer, a medium density polyethylene, a very low density polyethylene (VLDPE), a plastomer, a polypropylene/copolypropylene/heterophasic polypropylene, polyethylene terephthalate (PET), PLA (e.g., from Natureworks), polyhydroxyalkanoate (PHA), poly(ethylene-2,5-furandicarboxylate) (PEF), cellulose (available from, for example, Innovia), NYLON 11 (i.e., Rilsan® from Arkema), bio-polyesters, (e.g., those made from bio-glycerol, organic acid, and anhydride, as described in U.S. Patent Application No. 2008/0200591, incorporated herein by reference), polybutylene succinate, polyglycolic acid (PGA), and polyvinyl chloride (PVC). At least one of the constituents of polymer (A) is at least partially derived from a renewable resource.

In accordance with a second aspect, a laminate bi-layer film comprises a first film layer and a second film layer, wherein the bi-layer film has a bio-based content of about 10% to about 100% using ASTM D6866-10, method B. The first and second film layers are produced in independent steps and adhesively laminated together or the second film layer is coated onto the first film layer via extrusion coating, solvent coating, etc. Each of the two film layers has a thickness of from about 1 μm to about 750 μm and each is at least partially formed from a polymer (A). In one embodiment, each of the two film layers has a thickness of from about 1 μm to about 200 μm. When adhesively laminated, the tie layer has a thickness of about 1 μm to about 20 μm. Each of the two film layers comprises from about 75% to about 99% by weight of a polymer (A). The polymer (A) can be compositionally different in each of the two layers and comprises at least one or possibly more of a low density polyethylene (LDPE), a polar copolymer of polyethylene, a linear low density polyethylene (LLDPE), a high density homopolyethylene/high density polyethylene copolymer, a medium density polyethylene, a very low density polyethylene (VLDPE), a plastomer, a polypropylene/copolypropylene/heterophasic polypropylene, a nylon, a polyethyelenegterephthalate (PET), PLA (e.g., from Natureworks), polyhydroxyalkanoate (PHA), poly(ethylene-2,5-furandicarboxylate) (PEF), cellulose (available from, for example, Innovia), NYLON 11 (i.e., Rilsan® from Arkema), bio-polyesters, (e.g., those made from bio-glycerol, organic acid, and anhydride, as described in U.S. Patent Application No. 2008/0200591, incorporated herein by reference), polybutylene succinate, polyglycolic acid (PGA), and polyvinyl chloride (PVC). At east one of the constituents of polymer (A) is at least pary derived from a renewable resource.

In accordance with a third aspect, a laminant tri-layer film comprises a first film layer, a second film layer, and a third film layer with the first film layer disposed on one surface of the second film layer and the third film layer disposed on the other surface of the second film layer, wherein the tri-layer film has a bio-based content of about 10% to about 100% using ASTM D6866-10, method B. The first, second, and third film layers are produced in independent steps and adhesively laminated together or the first and third film layers are coated onto the second film layer via extrusion coating, solvent coating, etc. Each of the three film layers has a thickness of about 1 μm to about 750 μm and each is at least partially formed from a polymer (A). In one embodiment, each of the three film layers has a thickness of from about 1 μm to about 200 μm. When adhesively laminated, each tie layer has a thickness of about 1 μm to about 20 μm. Each of the three film layers comprises from about 75% to about 99% by weight of a polymer (A). The polymer (A) can be compositionally different in each of the three layers and comprises at least one or possibly more of a low density polyethylene (LDPE), a polar copolymer of polyethylene, a linear low density polyethylene (LLDPE), a high density homopolyethylene/high density polyethylene copolymer, a medium density polyethylene, a very low density polyethylene (VLDPE), a plastomer, a polypropylene/copolypropylene/heterophasic polypropylene, a nylon, a polyethyeleneterephthalate (PET), PLA (e.g., from Natureworks), polyhydroxyalkanoate (PHA), poly(ethylene-2,5-furandicarboxylate) (PEF), cellulose (available from, for example, Innovia), NYLON 11 (i.e., Rilsan® from Arkema), bio-polyesters, (e.g., those made from bio-glycerol, organic acid, and anhydride, as described in U.S. Patent Application No. 2008/0200591, incorporated herein by reference), polybutylene succinate, polyglycolic acid (PGA), and polyvinyl chloride (PVC). At least one of the constituents of polymer (A) is at least partially derived from a renewable resource.

In accordance with a fourth aspect, a laminant four-layer film comprises a first film layer, a second film layer, a third film layer, and a fourth film layer with the first film layer disposed on one surface of the second film layer, the third film layer disposed on the other surface of the second film layer, and the fourth film layer disposed on the surface of the third film layer not facing the second film layer wherein the four-layer film has a bio-based content of about 10% to about 100% using ASTM D6866-10, method B. The first, second, third film, and fourth layers are produced in independent steps and adhesively laminated together or the first and third film layers are coated onto the second film layer and the fourth layer is coated onto the third layer via extrusion coating, solvent coating, etc. Each of the four film layers has a thickness of about 1 μm to about 750 μm and each is at least partially formed from a polymer (A). In one embodiment, each of the four film layers has a thickness of from about 1 μm to about 200 μm. When adhesively laminated, each tie layer has a thickness of about 1 μm to about 20 μm. Each of the four film layers comprises from about 75% to about 99% by weight of a polymer (A). The polymer (A) can be compositionally different in each of the four layers and comprises at least one or possibly more of a low density polyethylene (LDPE), a polar copolymer of polyethylene, a linear low density polyethylene (LLDPE), a high density homopolyethylene/high density polyethylene copolymer, a medium density polyethylene, a very low density polyethylene (VLDPE), a plastomer, a polypropylene/copolypropylene/heterophasic polypropylene, a nylon, a polyethyeleneterephthalate (PET), PLA (e.g., from Natureworks), polyhydroxyalkanoate (PHA), poly(ethylene-2,5-furandicarboxylate) (PEF), cellulose (available from, for example, Innovia), NYLON 11 (i.e., Rilsan® from Arkema), bio-polyesters, (e.g., those made from bio-glycerol, organic acid, and anhydride, as described in U.S. Patent Application No. 2008/0200591, incorporated herein by reference), polybutylene succinate, polyglycolic acid (PGA), and polyvinyl chloride (PVC). At least one of the constituents of polymer (A) is at least partially derived from a renewable resource.

In accordance with a fifth aspect, a laminant five-layer film comprises a first film layer, a second film layer, a third film layer, a fourth film layer, and a fifth film layer with the first film layer disposed on one surface of the second film layer. the third film layer disposed on the other surface of the second film layer, the fourth film layer disposed on the other surface of the third film layer not facing the second film layer, and the fifth film layer disposed on the surface of the fourth film layer not facing the third film layer wherein the five-layer film has a bio-based content of about 10% to about 100% using ASTM D6866-10, method B. The first, second, third, fourth, and fifth film layers are produced in independent steps and adhesively laminated together or the first and third film layers are coated onto the second film layer, the fourth layer is coated onto the third layer, and the fifth layer is coated onto the fourth layer via extrusion coating, solvent coating, etc. Each of the five film layers has a thickness of from about 1 μm to about 750 μm and each is at least partially formed from a polymer (A). In one embodiment, each of the five film layers has a thickness of from about 1 μm to about 200 μm. When adhesively laminated, each tie layer has a thickness of about 1 μm to about 20 μm. Each of the five film layers comprises from about 75% to about 99% by weight of a polymer (A). The polymer (A) can be compositionally different in each of the five layers and comprises at least one or possibly more of a low density polyethylene (LDPE), a polar copolymer of polyethylene, a linear low density polyethylene (LLDPE), a high density homopolyethylene/high density polyethylene copolymer, a medium density polyethylene, a very low density polyethylene (VLDPE), a plastomer, a polypropylene/copolypropylene/heterophasic polypropylene, a nylon, a polyethyeleneterephthalate (PET), PLA (e.g., from Natureworks), polyhydroxyalkanoate (PHA), poly(ethylene-2,5-furandicarboxylate) (PEF), cellulose (available from, for example, Innovia), NYLON 11 (i.e., Rilsan® from Arkema), bio-polyesters, (e.g., those made from bio-glycerol, organic acid, and anhydride, as described in U.S. Patent Application No. 2008/0200591, incorporated herein by reference), polybutylene succinate, polyglycolic acid (PGA), and polyvinyl chloride (PVC). At least one of the constituents of polymer (A) is at least partially derived from a renewable resource.

### BRIEF DESCRIPTION OF THE DRAWINGS

FIG. 1 is a representative view of a multi-layer film having two layers; and

FIG. 2 is a representative view of a multi-layer film having three layers.

### DETAILED DESCRIPTION OF THE INVENTION

### I. Definitions

As used herein, the following terms shall have the meaning specified thereafter:

“Absorbent article” means devices that absorb and/or contain liquid. Wearable absorbent articles are absorbent articles placed against or in proximity to the body of the wearer to absorb and contain various exudates discharged from the body. Non-limiting examples of wearable absorbent articles include diapers, pant-like or pull-on diapers, training pants, sanitary napkins, tampons, panty liners, incontinence devices, and the like. Additional absorbent articles include wipes and cleaning products.

“Agricultural product” refers to a renewable resource resulting from the cultivation of land (e.g. a crop) or the husbandry of animals (including fish).

“Bio-based content” refers to the amount of carbon from a renewable resource in a material as a percent of the mass of the total organic carbon in the material, as determined by ASTM D6866-10, method B. Note that any carbon from inorganic sources such as calcium carbonate is not included in determining the bio-based content of the material.

“Communication” refers to a medium or means by which information, teachings, or messages are transmitted.

“Disposed” refers to an element being located in a particular place or position.

“Film” refers to a sheet-like material wherein the length and width of the material far exceed the thickness of the material.

“Monomeric compound” refers to an intermediate compound that may be polymerized to yield a polymer.

“Paper product”, as used herein, refers to any formed fibrous structure product, which may, but not necessarily, comprise cellulose fibers. In one embodiment, the paper products of the present disclosure include tissue-towel paper products.

“Petrochemical” refers to an organic compound derived from petroleum, natural gas, or coal.

“Petroleum” refers to crude oil and its components of paraffinic, cycloparaffinic, and aromatic hydrocarbons. Crude oil may be obtained from tar sands, bitumen fields, and oil shale.

“Polymer” refers to a macromolecule comprising repeat units where the macromolecule has a molecular weight of at least 1000 Daltons. The polymer may be a homopolymer, copolymer, terpoymer etc. The polymer may be produced via fee-radical, condensation, anionic, cationic, Ziegler-Natta, metallocene, or ring-opening mechanisms. The polymer may be linear, branched and/or crosslinked.

“Polyethylene” and “polypropylene” refer to polymers prepared from ethylene and propylene, respectively. The polymer may be a homopolymer, or may contain up to about 10 mol % of repeat units from a co-monomer.

“Polymers derived directly from renewable resources” refer to polymers obtained from a renewable resource without intermediates.

“Post-consumer recycled polymers” refer to synthetic polymers recovered after consumer usage and includes recycled polymers from plastic bottles, e.g., laundry, milk, and soda bottles.

“Related environmental message” refers to a message that conveys the benefits or advantages of the multi-layer film comprising a polymer derived from a renewable resource. Such benefits include being more environmentally friendly, having reduced petroleum dependence, being derived from renewable resources, and the like.

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

“Synthetic polymer” refers to a polymer which is produced from at least one monomer by a chemical process. A synthetic polymer is not produced directly by a living organism.

“Tissue-towel paper product”, as used herein, refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

### II. Polymers Derived from Renewable Resources

A number of renewable resources contain polymers that are suitable for use in multi-layer films (i.e., the polymer is obtained from the renewable resource without intermediates). Suitable extraction and/or purification steps may be necessary, but no intermediate compound is required. Such polymers derived directly from renewable resources include cellulose (e.g. pulp fibers), starch, chitin, polypeptides, poly(lactic acid), polyhydroxyalkanoates, and the like. These polymers may be subsequently chemically modified to improve end use characteristics (e.g., conversion of cellulose to yield carboxycellulose or conversion of chitin to yield chitosan). However, in such cases, the resulting polymer is a structural analog of the starting polymer. Polymers derived directly from renewable resources (i.e., with no intermediate compounds) and their derivatives are known. All of these materials, except for starch and its derivatives, are within the scope of the present disclosure.

Synthetic polymers of the present disclosure can be derived from a renewable resource via an indirect route involving one or more intermediate compounds. Suitable intermediate compounds derived from renewable resources include sugars. Suitable sugars include monosaccharides, disaccharides, trisaccharides, and oligosaccharides. Sugars such as sucrose, glucose, fructose, maltose may be readily produced from renewable resources such as sugar cane and sugar beets. Sugars may also be derived (e.g., via enzymatic cleavage) from other agricultural products such as starch or cellulose. For example, glucose may be prepared on a commercial scale by enzymatic hydrolysis of corn starch. While corn is a renewable resource in North America, other common agricultural crops may be used as the base starch for conversion into glucose. Wheat, buckwheat, arracaha, potato, barley, kudzu, cassaya, sorghum, sweet potato, yam, arrowroot, sago, and other like starchy fruit, seeds, or tubers are may also be used in the preparation of glucose.

Other suitable intermediate compounds derived from renewable resources include monofunctional alcohols such as methanol or ethanol and polyfunctional alcohols such as glycerol. Ethanol may be derived from many of the same renewable resources as glucose. For example, cornstarch may be enzymatically hydrolyzed to yield glucose and/or other sugars. The resultant sugars can be converted into ethanol by fermentation. As with glucose production, corn is an ideal renewable resource in North America; however, other crops may be substituted. Methanol may be produced from fermentation of biomass. Glycerol is commonly derived via hydrolysis of triglycerides present in natural fats or oils, which may be obtained from renewable resources such as animals or plants.

Other intermediate compounds derived from renewable resources include organic acids (e.g., citric acid, lactic acid, alginic acid, amino acids etc.), aldehydes (e.g., acetaldehyde), and esters (e.g., cetyl palmitate, methyl stearate, methyl oleate, etc.).

Additional intermediate compounds such as methane and carbon monoxide may also be derived from renewable resources by fermentation and/or oxidation processes.

Intermediate compounds derived from renewable resources may be converted into polymers (e.g., glycerol to polyglycerol) or they may be converted into other intermediate compounds in a reaction pathway which ultimately leads to a polymer useful in a multi-layer film. An intermediate compound may be capable of producing more than one secondary intermediate compound. Similarly, a specific intermediate compound may be derived from a number of different precursors, depending upon the reaction pathways utilized.

Particularly desirable intermediates include olefins. Olefins such as ethylene and propylene may also be derived from renewable resources. For example, methanol derived from fermentation of biomass may be converted to ethylene and or propylene, which are both suitable monomeric compounds, as described in U.S. Pat. Nos. 4,296,266 and 4,083,889. Ethanol derived from fermentation of a renewable resource may be converted into the monomeric compound ethylene via dehydration as described in U.S. Pat. No. 4,423,270. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol.

Charcoal derived from biomass can be used to create syngas (i.e., CO+H₂) from which hydrocarbons such as ethane and propane can be prepared (Fischer-Tropsch Process). Ethane and propane can be dehydrogenated to yield the monomeric compounds of ethylene and propylene.

Other sources of materials to form polymers derived from renewable resources include post-consumer recycled materials. Sources of synthetic post-consumer recycled materials can include plastic bottles, e.g., soda bottles, plastic films, plastic packaging materials, plastic bags and other similar materials which contain synthetic materials which can be recovered.

### III. Exemplary Synthetic Polymers

Olefins derived from renewable resources may be polymerized to yield polyolefins. Ethylene and propylene derived from renewable resources may be polymerized under the appropriate conditions to prepare polyethylene and/or polypropylene having desired characteristics for use in multi-layer films. The polyethylene and/or polypropylene may be high density, medium density, low density, or linear-low density. Further, polypropylene can include homo-PP. Polyethylene and/or polypropylene may be produced via free-radical polymerization techniques, or by using Ziegler-Natta (ZN) catalysis or Metallocene catalysts. Examples of such bio-sourced polyethylenes and polypropylenes are described in U.S. Publication Nos. 2010/0069691, 2010/0069589, 2009/0326293, and 2008/0312485; PCT Application Nos. WO2010063947 and WO2009098267; and European Patent No. 1102569. Other olefins that can be derived from renewable resources include butadiene and isoprene. Examples of such olefins are described in U.S. Publication Nos. 2010/0216958 and 2010/0036173.

Such polyolefins being derived from renewable resources can also be reacted to form various copolymers, including for example random block copolymers, such as ethylene-propylene random block copolymers (e.g., Borpact™ BC918CF manufactured by Borealis). Such copolymers and methods of forming same are contemplated and described for example in European Patent No. 2121318.

In addition, the polyolefin derived from a renewable resource may be processed according to methods known in the art into a form suitable for the end use of the polymer. The polyolefin may comprise mixtures or blends with other polymers such as polyolefins derived from petrochemicals.

Bio-polyethylene terephthalate is available from Teijin Fibers Ltd. It also can be produced from the polymerization of bio-ethylene glycol with bio-terephthalic acid. Bio-ethylene glycol can be derived from renewable resources via a number of suitable routes, such as, for example, those described in WO/2009/155086 and U.S. Pat. No. 4,536,584, each incorporated herein by reference. Bio-terephthalic acid can be derived from renewable alcohols through renewable p-xylene, as described in WO/2009/079213, which is incorporated herein by reference. In some embodiments, a renewable alcohol (e.g., isobutanol) is dehydrated over an acidic catalyst in a reactor to form isobutylene. The isobutylene is recovered and reacted under the appropriate high heat and pressure conditions in a second reactor containing a catalyst known to aromatize aliphatic hydrocarbons to form renewable p-xylene. In another embodiment, a renewable alcohol, e.g. isobutanol, is dehydrated and dimerized over an acid catalyst. The resulting diisobutylene is recovered and reacted in a second reactor to form renewable p-xylene. In yet another embodiment, a renewable alcohol, e.g. isobutanol, containing up to 15 wt. % water is dehydrated, or dehydrated and oligomerized, and the resulting oligomers are aromatized to form renewable p-xylene. Renewable phthalic acid or phthalate esters can be produced by oxidizing p-xylene over a transition metal catalyst (see, e.g., Ind. Eng. Chem. Res., 39:3958-3997 (2000)), optionally in the presence of one or more alcohols.

Bio-poly(ethylene-2,5-furandicarboxylate) (bio-PEF) can be produced according to the route disclosed in Werpy and Petersen, “Top Value Added Chemicals from Biomass. Volume I—Results of Screening for Potential Candidates from Sugars and Synthesis Gas, produced by the Staff at Pacific Northwest National Laboratory (PNNL); National Renewable Energy Laboratory (NREL), Office of Biomass Program (EERE),” 2004 and PCT Application No. WO 2010/077133, which are incorporated herein by reference.

It should be recognized that any of the aforementioned synthetic polymers (e.g., copolymers) may be formed by using a combination of monomers derived from renewable resources and monomers derived from non-renewable (e.g., petroleum) resources. For example, the copolymer can comprise propylene repeat units derived from a renewable resource and isobutylene repeat units derived from a petroleum source.

### IV. Mono and Multi-Layer Films Comprising the Synthetic Polymer Derived from Renewable Resources

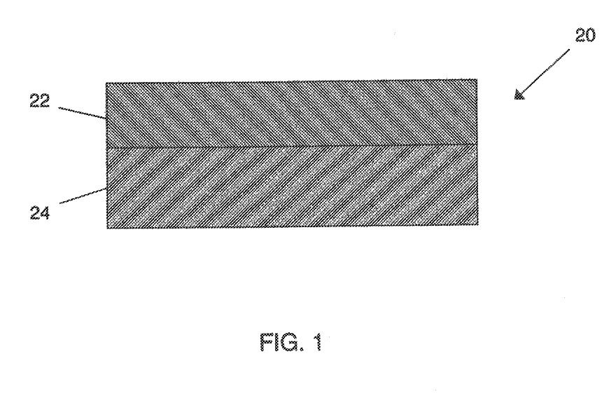

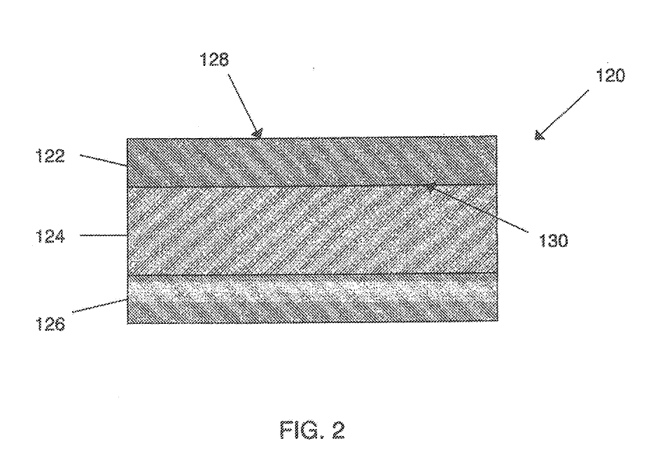

The present disclosure is directed toward mono and multi-layer films. Referring to FIG. 1, the invention comprises a multi-layer film 20 having at least two layers (e.g., a first film layer 22 and a second film layer 24). The first film layer 22 and the second film layer 24 can be layered adjacent to each other to form the multi-layer film (e.g., FIG. 1). As illustrated in FIG. 2, a multi-layer film 120 can have at least three layers (e.g., a first film layer 122, a second film layer 124 and a third film layer 126). As shown in FIG. 2, the second film layer 124 can at least partially overlie at least one of an upper surface 128 or a lower surface 130 of the first film layer 122. The third film layer 126 can at least partially overlie the second film layer 124 such that the second film layer 124 forms a core layer. In addition to the arrangements illustrated in FIGS. 1 and 2, it is contemplated that multi-layer films may include additional layers (e.g., adhesive layers, non-permeable layers, etc.).

While FIGS. 1 and 2 generally illustrate two and three layer arrangements for multi-layer films, it will be appreciated that such multi-layer films can comprise from 2 layers to about 1000 layers; in certain embodiments from 3 layers to about 200 layers; and in certain embodiments from about 5 layers to about 100 layers.

The multi-layer films contemplated herein can have a thickness (e.g., caliper) from about 10 microns to about 200 microns; in certain embodiments a thickness from about 20 microns to about 100 microns; and in certain embodiments a thickness from about 15 to 30 microns. For example, as illustrated in FIGS. 1 and 2, each of the film layers can have a thickness less than about 100 microns; in certain embodiments less than about 50 microns; and in certain embodiments less than about 10 microns. It will be appreciated that the respective film layers can have substantially the same or different thicknesses. Thickness of the multi-layer films can be evaluated using various techniques, including the methodology set forth in ISO 4593:1993, Plastics—Film and sheeting—Determination of thickness by mechanical scanning. In certain embodiments, where a sample of the multi-layer film comprises about a 1.0 inch diameter (having a basis weight from about 10 gsm to about 50 gsm), section 2.1.2 of ISO 4593:1993 will apply, such that a force applied to the sample shall be 0.1 N to 0.5 N. It will be appreciated that other suitable methods may be available to measure the thickness of the multi-layer film described herein.

Each respective layer of the multi-layer film can be formed from a number of the respective synthetic polymers described herein. The selection of polymers used to form the multi-layer film can have an impact on a number of physical parameters, and as such, can provide improved characteristics such as lower basis weights and higher tensile and seal strengths. Examples of commercial multi-layer films with improved characteristics are described in U.S. Pat. No. 7,588,706.

As illustrated by FIG. 1, the first film layer 22 can include a polymer (A) and a polymer (B). In one embodiment, the first film layer 22 can include from about 75% to about 99% by weight of the polymer (A); and in certain embodiments from about 85% to about 95% by weight of the polymer (A). In one embodiment, the first film layer 22 can include from about 1% to about 25% by weight of the polymer (B); and in certain embodiments from about 5% to about 10% by weight of the polymer (B). In one embodiment, the polymer (A) can include a synthetic polymer as described herein, and in particular, a polyethylene, such as LDPE or LLDPE. Examples of such suitable polyethylenes that can be used to form the first film layer are described in U.S. Pat. No. 7,588,706. In one embodiment, the polymer (B) can include a copolymer, such as an ethylene-propylene random block copolymer.

The second film layer 24 can include the polymer (A), the polymer (B) and a polymer (C). In one embodiment, the second film layer 24 can include from about 20% to about 90% by weight of the polymer (A); and in certain embodiments from about 30% to about 85% by weight of the polymer (A). In one embodiment, the second film layer 24 can include from about 35% to about 60% by weight of the polymer (B); and in certain embodiments from about 40% to about 50% by weight of the polymer (B). In one embodiment, the second film layer 24 can include from about 1% to about 35% by weight of the polymer (C); and in certain embodiments from about 3% to about 25% by weight of the polymer (C). In one embodiment, the second film layer 24 can include from about 40% to about 75% by weight of the polymer (A) and an additive material. In certain embodiments, the second film layer 24 can include from about 25% to about 60% by weight of the polymer (B) and polymer (C). Polymer (C) can include polypropylenes (e.g., homo-PP). Such suitable polypropylenes are described in European Patent No. 2121318. In certain embodiments, the second film layer 24 can optionally include an opacifying agent (e.g., titanium dioxide, calcium carbonate) which can provide increased opacity to the multi-layer film. Moreover, each of the polymer (A), polymer (B) and polymer (C) can be synthetic and at least partially derived from a renewable resource. In certain embodiments, where the polymer (B) is present in both the first film layer and the second film layer provided additional advantages. Such advantages include better interfacial interaction between the respective layers, thus providing better adhesion between the film layers, particularly when the polymer (B) is an ethylene-propylene random block copolymer.

As illustrated in FIG. 2, a multi-layer film can include a 3-layer arrangement wherein a first film layer 122 and a third film layer 126 form the skin layers and a second film layer 124 is formed between the first film layer 122 and the third film layer 126 to form a core layer. The first film layer 122 and the second film layer 124 of FIG. 2 can be similarly formed as the first film layer 22 and the second film layer 24 of FIG. 1. The third film layer 126 can be the same or different from the first film layer 122, such that in certain embodiments, the third film layer 126 can include the polymer (A) and polymer (B) as described herein. It will be appreciated that similar film layers could be used to form multi-layer films having more than 3 layers. Furthermore, in certain embodiments, the S-layer arrangement as illustrated in FIG. 2 can provide a multi-layer film having from about 40% to about 90% by weight of the polymer (A), from about 5% to about 50% by weight of the polymer (B) and from about 1% to about 20% by weight of the polymer (C).

In addition to being formed from the synthetic polymers described herein, the layers of the multi-layer films can further include additional additives. For example, opacifying agents can be added to one or more of the film layers. Such opacifying agents can include iron oxides, carbon black, aluminum, aluminum oxide, titanium dioxide, talc and combinations thereof. These opacifying agents can comprise about 0.1% to about 5% by weight of the multi-layer films; and in certain embodiments, the opacifying agents can comprise about 0.3% to about 3% of the multi-layer polymeric films. It will be appreciated that other suitable opacifying agents may be employed and in various concentrations. Examples of opacifying agents are described in U.S. Pat. No. 6,653,523.

Furthermore, the multi-layer films may comprise other additives, such as other polymers (e.g., a polypropylene, a polyethylene, a ethylene vinyl acetate, a polyethyelene terephthalate, a polymethylpentene, any combination thereof, or the like), a filler (e.g., glass, talc, calcium carbonate, or the like), a mold release agent, a flame retardant, an electrically conductive agent, an anti-static agent, a pigment, an antioxidant, an impact modifier, a stabilizer (e.g., a UV absorber), wetting agents, dyes, or any combination thereof.

### V. Method of Making a Multi-Layer Film Having a Polymer Derived from a Renewable Resource

The present disclosure further relates to a method for making a mono- or multi-layer film comprising a polymer derived from a renewable resource. In one embodiment, the method comprises the steps of providing a renewable resource; deriving an intermediate monomer from the renewable resource; polymerizing the intermediate monomer to form a synthetic polymer and incorporating the synthetic polymer into a mono- or multi-layer film. In another embodiment, the method comprises the steps of isolating a renewable polymer from a natural source and incorporating the renewable polymer into a mono- or multi-layer film. In another embodiment, the method comprises the steps of isolating a renewable polymer from a natural source, providing a renewable resource; deriving an intermediate monomer from the renewable resource; polymerizing the intermediate monomer to form a synthetic polymer and combining both the renewable polymer and the synthetic polymer into a mono- or multi-layer film. The present disclosure further relates to providing one or more of the multi-layer films to a consumer and communicating reduced petrochemical usage to the consumer. The renewable and synthetic polymers derived from renewable resources may undergo additional process steps prior to incorporation into the mono- or multi-layer films.

The present disclosure further relates to a method for making the layered arrangement for a multi-layer film. Multi-layer films can be made by known layering processes typically using a uni-axial cast or planar sheet process or lamination. Coextruded cast film or sheet structures typically have 2 to 5 layers; however, cast film or sheet structures including hundreds of layers are known. For example, early multi-layer processes and structures are shown in U.S. Pat. No. 3,565,985; U.S. Pat. No. 3,557,265; and U.S. Pat. No. 3,884,606. WO 2008/008875 discloses a related art method of forming multi-layered structures having many, for example fifty to several hundred, alternating layers of film. In one method for making a multi-layer film, the number of layers may be multiplied by the use of a device as described in U.S. Pat. No. 3,759,647. Other methods are further described in U.S. Pat. Nos. 5,094,788 and 6,413,595. Here, a first stream comprising discrete, overlapping layers of the one or more materials is divided into a plurality of branch streams, these branch streams are redirected or repositioned and individually symmetrically expanded and contracted, the resistance to flow through the apparatus and thus the flow rates of each of the branch streams are independently adjusted, and the branch streams recombined in overlapping relationship to form a second stream having a greater number of discrete, overlapping layers of the one or more materials distributed in the prescribed gradient or other distribution. In certain embodiments, thin layers can be formed on spiral channel plates and these layers can flow into the central annular channel where micro-layer after micro-layer can then be stacked inside traditional thick layers. Such examples are described in U.S. Patent Publication No. US 2010/0072655 A1. A plurality of layers may be made in blown films by various methods. In US 2010/0072655A1, two or more incoming streams are split and introduced in annular fashion into a channel with alternating plurality of microlayers that are surrounded by standard layer polymeric streams to form blown films containing microlayer regions. For annular dies, a known microlayer process for creating a plurality of alternating layers is made by distributing the flow of the first polymer stream into every odd internal microlayer layer and distributing the flow of the second polymer stream into every even microlayer. This microlayer group is then introduced between channels of polymer streams of standard thickness. Layer multiplication technology for cast films is marketed by companies such as Extrusion Dies Industries, Inc. of Chippewa Falls, Wis. and Cloeren Inc. of Orange, Tex. Microlayer and nanolayer technology for blown films is marketed by BBS Corporation of Simpsonville, S.C.

Other manufacturing options include simple blown film processes, as described, for example, in The Encyclopedia of Chemical Technology, Kirk-Othmer, Third Edition, John Wiley & Sons, New York, 1981, Vol. 16, pp. 416-417 and Vol. 18, pp. 191-192, the disclosures of which are incorporated herein by reference. Processes for manufacturing biaxially oriented film such as the “double bubble” process described in U.S. Pat. No. 3,456,044 (Pahlke), and other suitable processes for preparing biaxially stretched or oriented film are described in U.S. Pat. No. 4,865,902 (Golike et al.), U.S. Pat. No. 4,352,849 (Mueller), U.S. Pat. No. 4,820,557 (Warren), U.S. Pat. No. 4,927,708 (Herran et al.), U.S. Pat. No. 4,963,419 (Lustig et al.), and U.S. Pat. No. 4,952,451 (Mueller). The film structures can also be made as described in a tenter-frame technique, such as that used for oriented polypropylene.

Other multi-layer film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 1-80 (published by TAPPI Press (1992).

The multi-layer films can be laminated onto another layer(s) in a secondary operation, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, June 15-17 (1981), pp. 211-229, the disclosure of which is incorporated herein by reference. If a monolayer film layer is produced via tubular film (i.e., blown film techniques) or flat die (i.e., cast film) as described by K. R. Osborn and W. A. Jenkins in “Plastic Films, Technology and Packaging Applications” (Technomic Publishing Co., Inc. (1992)), then the film must go through an additional post-extrusion step of adhesive or extrusion lamination to other packaging material layers to form a multi-layer film. If the film is a coextrusion of two or more layers (also described by Osborn and Jenkins), the film may still be laminated to additional layers of packaging materials, depending on the other physical requirements of the final film. “Laminations Vs. Coextrusion” by D. Dumbleton (Converting Magazine (September 1992), also discusses lamination versus coextrusion. The multi-layer films contemplated herein can also go through other post extrusion techniques, such as a biaxial orientation process.

### VI. Validation of Polymers Derived from Renewable Resources

A suitable validation technique is through ¹⁴C analysis. A small amount of the carbon dioxide in the atmosphere is radioactive. This ¹⁴C carbon dioxide is created when nitrogen is struck by an ultra-violet light produced neutron, causing the nitrogen to lose a proton and form carbon of molecular weight 14 which is immediately oxidized to carbon dioxide. This radioactive isotope represents a small but measurable fraction of atmospheric carbon. Atmospheric carbon dioxide is cycled by green plants to make organic molecules during photosynthesis. The cycle is completed when the green plants or other forms of life metabolize the organic molecules, thereby producing carbon dioxide which is released back to the atmosphere. Virtually all forms of life on Earth depend on this green plant production of organic molecules to grow and reproduce. Therefore, the ¹⁴C that exists in the atmosphere becomes part of all life forms, and their biological products. In contrast, fossil fuel based carbon does not have the signature radiocarbon ratio of atmospheric carbon dioxide.

Assessment of the renewably based carbon in a material can be performed through standard test methods. Using radiocarbon and isotope ratio mass spectrometry analysis, the bio-based content of materials can be determined. ASTM International, formally known as the American Society for Testing and Materials, has established a standard method for assessing the bio-based content of materials. The ASTM method is designated ASTM D6866-10.

The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, for example, it would give a radiocarbon signature near 54 pMC (assuming the petroleum derivatives have the same percentage of carbon as the soybeans).

A biomass content result is derived by assigning 100% equal to 107.5 pMC and 0% equal to 0 pMC. In this regard, a sample measuring 99 pMC will give an equivalent bio-based content value of 92%.

Assessment of the materials described herein was done in accordance with ASTM D6866. The mean values encompass an absolute range of 6% (plus and minus 3% on either side of the bio-based content value) to account for variations in end-component radiocarbon signatures. It is presumed that all materials are present day or fossil in origin and that the desired result is the amount of bio-based component “present” in the material, not the amount of bio-based material “used” in the manufacturing process.

In one embodiment, a mono-layer film comprises a bio-based content value from about 10% to about 100% using ASTM D6866-10, method B. In another embodiment, a mono-layer film comprises a bio-based content value from about 20% to about 100% using ASTM D6866-10, method B. In yet another embodiment, a mono-layer film comprises a bio-based content value from about 50% to about 100% using ASTM D6866-10, method B.

In one embodiment, a multi-layer film comprises a bio-based content value from about 10% to about 100% using ASTM D6866-10, method B. In another embodiment, a multi-layer film comprises a bio-based content value from about 20% to about 100% using ASTM D6866-10, method B. In yet another embodiment, a multi-layer film comprises a bio-based content value from about 50% to about 100% using ASTM D6866-10, method B.

In order to apply the methodology of ASTM D6866-10 to determine the bio-based content of a mono- or multi-layer film, a representative sample of the component must be obtained for testing. In one embodiment, a representative portion of the mono- or multi-layer film can be ground into particulates less than about 20 mesh using known grinding methods (e.g., Wiley® mill), and a representative sample of suitable mass taken from the randomly mixed particles.

### VII. Communicating a Related Environmental Message a Consumer

The present disclosure relating to mono- and multi-layer films derived from renewable resources, further provides means for which to communicate an environmental message to a consumer. Such messages could be displayed on the multi-layer films, in such circumstances where the films are used as packaging materials for absorbent articles (e.g., diapers). The related environmental message may convey the benefits or advantages of the mono- or multi-layer film comprising a polymer derived from a renewable resource. The related environmental message may identify the mono- or multi-layer film as: being environmentally friendly or Earth friendly; having reduced petroleum (or oil) dependence or content; having reduced foreign petroleum (or oil) dependence or content; having reduced petrochemicals or having components that are petrochemical free; and/or being made from renewable resources or having components made from renewable resources. This communication is of importance to consumers that may have an aversion to petrochemical use (e.g., consumers concerned about depletion of natural resources or consumers who find petrochemical based products unnatural or not environmentally friendly) and to consumers that are environmentally conscious. Without such a communication, the benefit of the present disclosure may be lost on some consumers.

The communication may be effected in a variety of communication forms. Suitable communication forms include store displays, posters, billboard, computer programs, brochures, package literature, shelf information, videos, advertisements, internet web sites, pictograms, iconography, or any other suitable form of communication. The information could be available at stores, on television, in a computer-accessible form, in advertisements, or any other appropriate venue. Ideally, multiple communication forms may be employed to disseminate the related environmental message.

The communication may be written, spoken, or delivered by way of one or more pictures, graphics, or icons. For example, a television or internet based-advertisement may have narration, a voice-over, or other audible conveyance of the related environmental message. Likewise, the related environmental message may be conveyed in a written form using any of the suitable communication forms listed above. In certain embodiments, it may be desirable to quantify the reduction of petrochemical usage of the present multi-layer films compared to multi-layer films that are presently commercially available.

The related environmental message may also include a message of petrochemical equivalence. Many renewable, naturally occurring, or non-petroleum derived polymers are known. However, these polymers often lack the performance characteristics that consumers have come to expect when used in conjunction with mono- or multi-layer films. Therefore, a message of petroleum equivalence may be necessary to educate consumers that the polymers derived from renewable resources, as described above, exhibit equivalent or better performance characteristics as compared to petroleum derived polymers. A suitable petrochemical equivalence message can include comparison to mono- or multi-layer films that do not have a polymer derived from a renewable resource. For example, a suitable combined message may be, “Packaging for Product Brand A with an environmentally friendly material is just as effective as Packaging for Product Brand B.” This message conveys both the related environmental message and the message of petrochemical equivalence.

The films of the present invention in any of the aspects can optionally include a colorant masterbatch. As used herein, a “colorant masterbatch” refers to a mixture in which pigments are dispersed at high concentration in a carrier material. The colorant masterbatch is used to impart color to the final product. In some embodiments, the carrier is a bio-based plastic or a petroleum-based plastic, while in alternative embodiments, the carrier is a bio-based oil or a petroleum-based oil. The colorant masterbatch can be derived wholly or partly from a petroleum resource, wholly or partly from a renewable resource, or wholly or partly from a recycled resource. Nonlimiting examples of the carrier include bio-derived or oil derived polyethylene (e.g., linear low-density polyethylene (LLDPE), low-density polyethylene (LDPE), high-density polyethylene (HDPE)), bio-derived oil (e.g., olive oil, rapeseed oil, peanut oil, soybean oil, or hydrogenated plant-derived oils), petroleum-derived oil, recycled oil, bio-derived or petroleum derived polyethylene terephthalate, polypropylene, and a mixture thereof. The pigment of the carrier, which can be derived from either a renewable resource or a non-renewable resource, can include, for example, an inorganic pigment, an organic pigment, a polymeric resin, or a mixture thereof. Nonlimiting examples of pigments include titanium dioxide (e.g., rutile, anatase), copper phthalocyanine, antimony oxide, zinc oxide, calcium carbonate, fumed silica, phthalocyamine (e.g., phthalocyamine blue), ultramarine blue, cobalt blue, monoazo pigments, diazo pigments, acid dye, base dye, quinacridone, and a mixture thereof. In some embodiments, the colorant masterbatch can further include one or more additives, which can either be derived from a renewable resource or a non-renewable resource. Nonlimiting examples of additives include slip agents, UV absorbers, nucleating agents, UV stabilizers, heat stabilizers, clarifying agents, fillers, brighteners, process aids, perfumes, flavors, and a mixture thereof.

In some embodiments, color can be imparted to the films of the present invention in any of the aspects by using direct compounding (i.e., in-line compounding). In these embodiments, a twin screw compounder is placed at the beginning of the injection molding, blow molding, or film line and additives, such as pigments, are blended into the resin just before article formation.

Additional materials may be incorporated into the films of the present invention in any of the aspects to improve the strength or other physical characteristics of the plastic. Such additional materials include an inorganic salt, such as calcium carbonate, calcium sulfate, talcs, clays (e.g., nanoclays), aluminum hydroxide, CaSiO3, glass fibers, glass spheres, crystalline silicas (e.g., quartz, novacite, crystallobite), magnesium hydroxide, mica, sodium sulfate, lithopone, magnesium carbonate, iron oxide, or a mixture thereof.

The films of the present invention may be used to make a variety of useful articles, including sachets, pouches, bags and labels. The films of the present invention can be used in the construction of a thermoplastic bag which may be used as a liner for trash receptacles and refuse containers. The bag may be made from a first sidewall having multiple layers and an opposing, second sidewall having multiple layers that may be overlaid and joined to the first sidewall to define an interior volume. The first and second sidewalls are rectangular in shape, but in other embodiments may have other suitable shapes. The un-joined top edges may be separated or pulled apart to open the bag. The bag may be fitted with a draw tape to close the opening of the bag when, for example, disposing of the trash receptacle liner. Other aspects of the bag, including standard construction techniques for the top, sides and bottom of the trash bag, are known to those skilled in the art.

In some alternative embodiments to any of the embodiments described herein, elements of the film, including the substrates, sealant, barrier material, tie layers, or mixtures thereof include recycled material in place of or in addition to biobased material in an amount of up to 100% of the biobased material. As used herein, “recycled” materials encompass post-consumer recycled (PCR) materials, post-industrial recycled (PIR) materials, and a mixture thereof.

### EXAMPLES

The following are various examples of the present invention. The examples are divided into monolayer, bi-layer, tri-layer, four layer and five layer films. For the sake of clarity, print, foil, silicone release, and paper elements are not considered as ‘layers.’

### Monolayer Films

### Example #1

A monolayer film of thickness equal to 25 micron containing a blend of LDPE and LLDPE w/between 10 and 100% bio-based content. The film is printed. The film is used as an outer-wrap for packaging consumer paper products.

### Example #2

A monolayer film of thickness equal to 30 micron containing a blend of LDPE and LLDPE w/between 10 and 100% bio-based content. The film is printed. The film is used as an outer-wrap for packaging consumer paper products.

### Example #3

A monolayer film of thickness equal to 38 micron containing a blend of LDPE and LLDPE w/between 10 and 100% bio-based content. The film is printed. The film is used as an outer-wrap for packaging consumer paper products.

### Example #4

A monolayer film of thickness equal to 30 micron containing a blend of LDPE and LLDPE w/between 10 and 100% bio-based content. The film contains 4% TiO2. The film is used as an outer-wrap for packaging consumer paper products.

### Example #5

A monolayer film of thickness equal to 38 micron containing a blend of LDPE and LLDPE w/between 10 and 100% bio-based content. The film contains 4% TiO2. The film is used as an outer-wrap for packaging consumer paper products.

### Example #6

A monolayer film of thickness equal to 44 micron containing a blend of LDPE and LLDPE w/between 10 and 100% bio-based content. The film is printed. The film is used as an outer-wrap for packaging consumer paper products.

### Example #7

A monolayer film of thickness equal to 50 micron containing a blend of LDPE and LLDPE w/between 10 and 100% bio-based content. The film is printed. The film is used as an outer-wrap for packaging consumer paper products.

### Example #8

A monolayer film of thickness equal to 70 micron containing a blend of homo-polymer PP, coPolymer PP, LDPE and LLDPE w/between 10 and 100% bio-based content. The film is printed. The film is used as an outer-wrap for packaging consumer paper products.

### Example #9

A monolayer film of thickness equal to 25 micron containing a blend of LDPE, LLDPE, and EVA w/between 10 and 100% bio-based content. The film is printed. The film is used as an outer-wrap for packaging consumer paper products.

### Example #10

A monolayer film of thickness equal to 30 micron containing a blend of LDPE, LLDPE, and EVA w/between 10 and 100% bio-based content. The film is printed. The film is used as an outer-wrap for packaging consumer paper products.

### Example #11

A monolayer film of thickness equal to 38 micron containing a blend of LDPE, LLDPE, and EVA w/between 10 and 100% bio-based content. The film is printed. The film is used as an outer-wrap for packaging consumer paper products.

### Example #12

A monolayer film of thickness equal to 30 micron containing a blend of LDPE, LLDPE, and EVA w/between 10 and 100% bio-based content. The film contains 4% TiO2. The film is used as an outer-wrap for packaging consumer paper products.

### Example #13

A monolayer film of thickness equal to 38 micron containing a blend of LDPE, LLDPE, and EVA w/between 10 and 100% bio-based content. The film contains 4% TiO2. The film is used as an outer-wrap for packaging consumer paper products.

### Example #14

A monolayer film of thickness equal to 44 micron containing a blend of LDPE, LLDPE, and EVA w/between 10 and 100% bio-based content. The film is printed. The film is used as an outer-wrap for packaging consumer paper products.

### Example #15

A monolayer film of thickness equal to 50 micron containing a blend of LDPE, LLDPE, and EVA w/between 10 and 100% bio-based content. The film is printed. The film is used as an outer-wrap for packaging consumer paper products.

### Example #16

A monolayer film of thickness equal to 70 micron containing a blend of LDPE, LLDPE, and EVA w/between 10 and 100% bio-based content. The film is printed. The film is used as an outer-wrap for packaging consumer paper products.

### Example #17

A monolayer film of thickness equal to 25 micron containing a blend of LDPE and LLDPE w/between 10 and 100% bio-based content. The film also contains 4% TiO2 and 0.5% surfactant. The film is vacuum formed to produce a 3-D expanded film for use as a fluid control member in hygiene products.

### Example #18

A monolayer film of basis weight equal to 16 gsm containing a blend of LDPE, HDPE, and LLDPE w/between 10 and 100% bio-based content. The film also contains 55% CaCO3. The film is stretched in both the MD and CD to achieve breathability. The film is used as a breathable backsheet in hygiene applications.

### Example #19

A monolayer film of basis weight equal to 16 gsm containing a blend of LDPE, LLDPE, and PP w/between 10 and 100% bio-based content. The film also contains 55% CaCO3. The film is stretched in both the MD and CD to achieve breathability. The film is used as a breathable backsheet in hygiene applications.

### Example #20

A monolayer film of thickness equal to 25 micron containing a blend of LDPE and LLDPE w/between 10 and 100% bio-based content. The film also contains 4% colorant. The film is coated with a 5 micron layer of crosslinked PDMS. The film is used a release film in hygiene applications.

### Example #21

A monolayer film of thickness equal to 25 micron containing a blend of LDPE and LLDPE and PP or coPP w/between 10 and 100% bio-based content. The film also contains a release additive that blooms to the surface both during and after production. The release additive is based upon EBS and PDMS-block-amide. The film is used a release film in hygiene applications.

### Example #22

A film of composed of 30 micron OPP. The film contains a print layer and an exterior laquer surface coating. The film is used as an exterior packaging for personal cleansing products. The OPP is produced from 10 to 100% bio-based content.

### Example #23

A film of the following structural composition: Laquer/Print Layer/48 gsm paper/adhesive/12 micron PET/adh/25 micron aluminum/acrylic coating. The film is used a packaging film for pharmaceuticals. The PET layer is produced from 10 to 100% bio-based content.

### Example #24

A film of the following structural composition: Laquer/Print Layer/48 gsm paper/adhesive/12 micron PET/peelable seal/20 micron aluminum/acrylic coating. The film is used a packaging film for pharmaceuticals. The PET layer is produced from 10 to 100% bio-based content.

### Example #25

A film of the following structural composition: Laquer/Print Layer/48 gsm paper/adhesive/12 micron PET/peelable seal/20 micron aluminum/acrylic coating. The film is used a packaging film for pharmaceuticals. The PET layer is produced from 10 to 100% bio-based content.

### Bilayer Films

### Example #26

A bilayer film of thickness equal to 63 micron containing layer A and layer B. Layer A is 30 micron and is a blend of LDPE and LLDPE. Layer B is 30 micron and is a blend of LDPE and LLDPE and contains 2% TiO2. Layer A is reverse printed and adhered to layer B. 3 microns of adhesive are used to combine layer A and B. The film is used as a bag material in dry laundry. The LL/LD components contain from about 10 to 100% bio-based content.

### Example #27

A bilayer film of thickness equal to 63 micron containing layer A and layer B. Layer A is 30 microns and is a blend of LDPE, LLDPE, and EVA. Layer B is 30 microns and a blend of LDPE, LLDPE, and EVA and contains 2% TiO2. Layer A is reverse printed and adhered to layer B. 3 microns of adhesive are used to combine layer A and B. The film is used as a bag material in dry laundry. The LL/LD/EVA components contain from about 10 to 100% bio-based content.

### Example #28

A bilayer film of thickness equal to 80 micron containing layer A and layer B. Layer A is 38 micron and is a blend of LDPE and LLDPE. Layer B is 38 micron and is a blend of LDPE and LLDPE and contains 2% TiO2. Layer A is reverse printed and adhered to layer B. 4 microns of adhesive are used to combine layer A and B. The film is used as a bag material in dry laundry. The LL/LD components contain from about 10 to 100% bio-based content.

### Example #29

A bilayer film of thickness equal to 80 micron containing layer A and layer B. Layer A is 38 microns and is a blend of LDPE, LLDPE, and EVA. Layer B is 38 microns and a blend of LDPE, LLDPE, and EVA and contains 2% TiO2. Layer A is reverse printed and adhered to layer B. 4 microns of adhesive are used to combine layer A and B. The film is used as a bag material in dry laundry. The LL/LD/EVA components contain from about 10 to 100% bio-based content.

### Example #30

A bilayer film of thickness equal to 100 micron containing layer A and layer B. Layer A is 30 micron and is a blend of LDPE and LLDPE. Layer B is 70 micron and is a blend of LDPE and LLDPE and contains 2% TiO2. Layer A is reverse printed and adhered to layer B. The film is used as a bag material in dry laundry. The LL/LD components contain from about 10 to 100% bio-based content.

### Example #31

A bilayer film of thickness equal to 100 micron containing layer A and layer B. Layer A is 30 microns and is a blend of LDPE, LLDPE, and EVA. Layer B is 70 microns and a blend of LDPE, LLDPE, and EVA and contains 2% TiO2. Layer A is reverse printed and adhered to layer B. The film is used as a bag material in dry laundry. The LL/LD/EVA components contain from about 10 to 100% bio-based content.

### Example #32

A bilayer film of thickness equal to 120 micron containing layer A and layer B. Layer A is 50 micron and is a blend of LDPE and LLDPE. Layer B is 70 micron and is a blend of LDPE and LLDPE and contains 2% TiO2. Layer A is reverse printed and adhered to layer B. The film is used as a bag material in dry laundry. The LL/LD components contain from about 10 to 100% bio-based content.

### Example #26

A bilayer film of thickness equal to 120 micron containing layer A and layer B. Layer A is 50 microns and is a blend of LDPE, LLDPE, and EVA. Layer B is 70 microns and a blend of LDPE, LLDPE, and EVA and contains 2% TiO2. Layer A is reverse printed and adhered to layer B. The film is used as a bag material in dry laundry. The LL/LD/EVA components contain from about 10 to 100% bio-based content.

### Example #27

A bilayer film of thickness equal to 130 micron containing layer A and layer B. Layer A is 60 micron and is a blend of LDPE and LLDPE. Layer B is 70 micron and is a blend of LDPE and LLDPE and contains 2% TiO2. Layer A is reverse printed and adhered to layer B. The film is used as a bag material in dry laundry. The LL/LD components contain from about 10 to 100% bio-based content.

### Example #28

A bilayer film of thickness equal to 130 micron containing layer A and layer B. Layer A is 60 microns and is a blend of LDPE, LLDPE, and EVA. Layer B is 70 microns and a blend of LDPE, LLDPE, and EVA and contains 2% TiO2. Layer A is reverse printed and adhered to layer B. The film is used as a bag material in dry laundry. The LL/LD/EVA components contain from about 10 to 100% bio-based content.

### Example #29

A bilayer film of thickness equal to 150 micron containing layer A and layer B. Layer A is 80 micron and is a blend of LDPE and LLDPE. Layer B is 70 micron and is a blend of LDPE and LLDPE and contains 2% TiO2. Layer A is reverse printed and adhered to layer B. The film is used as a bag material in dry laundry. The LL/LD components contain from about 10 to 100% bio-based content.

### Example #30

A bilayer film of thickness equal to 150 micron containing layer A and layer B. Layer A is 80 microns and is a blend of LDPE, LLDPE, and EVA. Layer B is 70 microns and a blend of LDPE, LLDPE, and EVA and contains 2% TiO2. Layer A is reverse printed and adhered to layer B. The film is used as a bag material in dry laundry. The LL/LD/EVA components contain from about 10 to 100% bio-based content.

### Example #31

A film of the following structural composition: 12 micron PET/Reverse print layer/adhesive/20 micron LL & LDPE. The film is used as a packaging film for laundry products. The LL/LD/PET components contain from about 10 to 100% bio-based content.

### Example #32

A film of the following structural composition: 12 micron PET/Reverse print layer/adhesive/25 micron LL & LDPE. The film is used as a packaging film for laundry products. The LL/LD/PET components contain from about 10 to 100% bio-based content.

### Example #33

A film of the following structural composition: 12 micron PET/Reverse print layer/adhesive/30 micron LL & LDPE. The film is used as a packaging film for laundry products. The LL/LD/PET components contain from about 10 to 100% bio-based content.

### Example #34

A film of the following structural composition: 12 micron PET/Reverse print layer/adhesive/38 micron LL & LDPE. The film is used as a packaging film for laundry products. The LL/LD/PET components contain from about 10 to 100% bio-based content.

### Example #35

A film of the following structural composition: 12 micron PET/Reverse print layer/adhesive/50 micron LL & LDPE. The film is used as a packaging film for laundry products. The LL/LD/PET components contain from about 10 to 100% bio-based content

### Example #36

A film of the following structural composition: 12 micron PET/Reverse print layer/adhesive/60 micron LL & LDPE. The film is used as a packaging film for laundry products. The LL/LD/PET components contain from about 10 to 100% bio-based content

### Example #37

A film of the following structural composition: 12 micron PET/Reverse print layer/adhesive/70 micron LL & LDPE. The film is used as a packaging film for laundry products. The LL/LD/PET components contain from about 10 to 100% bio-based content

### Example #38

A film of the following structural composition: 12 micron PET/Reverse print layer/adhesive/80 micron LL & LDPE. The film is used as a packaging film for laundry products. The LL/LD/PET components contain from about 10 to 100% bio-based content

### Example #39

A film of the following structural composition: 12 micron PET/Reverse print layer/adhesive/90 micron LL & LDPE. The film is used as a packaging film for laundry products. The LL/LD/PET components contain from about 10 to 100% bio-based content

### Example #40

A film of the following structural composition: 12 micron PET/Reverse print layer/adhesive/110 micron LL & LDPE. The film is used as a packaging film for laundry products. The LL/LD/PET components contain from about 10 to 100% bio-based content

### Example #41

A film of the following structural composition: 12 micron PET/Reverse print layer/adhesive/120 micron LL & LDPE. The film is used as a packaging film for laundry products. The LL/LD/PET components contain from about 10 to 100% bio-based content.

### Example #42

A film of the following structural composition: 12 micron PET/Reverse print layer/adhesive/140 micron LL & LDPE. The film is used as a packaging film for laundry products. The LL/LD/PET components contain from about 10 to 100% bio-based content

### Example #43

A film of the following structural composition: 12 micron PET/Reverse print layer/adhesive/150 micron LL & LDPE. The film is used as a packaging film for laundry products. The LL/LD/PET components contain from about 10 to 100% bio-based content

### Example #44

A film of the following structural composition: 12 micron PET/Reverse print layer/adhesive/170 micron LL & LDPE. The film is used as a packaging film for laundry products. The LL/LD/PET components contain from about 10 to 100% bio-based content

### Example #45

A film of the following structural composition: 12 micron PET/Reverse print layer/adhesive/180 micron LL & LDPE. The film is used as a packaging film for laundry products. The LL/LD/PET components contain from about 10 to 100% bio-based content

### Example #46

A film of the following structural composition: 12 micron PET/Reverse print layer/adhesive/190 micron LL & LDPE. The film is used as a packaging film for laundry products. The LL/LD/PET components contain from about 10 to 100% bio-based content

### Example #47

A film of the following structural composition: 12 micron PET/Reverse print layer/adhesive/220 micron LL & LDPE. The film is used as a packaging film for laundry products. The LL/LD/PET components contain from about 10 to 100% bio-based content

### Example #48

A film of the following structural composition: 12 micron PET/Reverse print layer/adhesive/30 micron metalocene LL & LDPE. The film is used as a packaging film for laundry products. The LL/LD/PET components contain from about 10 to 100% bio-based content

### Example #49

A film of the following structural composition: 15 micron nylon/Reverse print layer/adhesive/100 micron LL & LDPE. The film is used as a packaging film for laundry products. The LL/LD/nylon components contain from about 10 to 100% bio-based content.

### Example #50

A film of the following structural composition: 15 micron nylon/Reverse print layer/adhesive/120 micron LL & LDPE. The film is used as a packaging film for laundry products. The LL/LD/nylon components contain from about 10 to 100% bio-based content.

### Example #51

A film of the following structural composition: 15 micron nylon/Reverse print layer/adhesive/130 micron LL & LDPE. The film is used as a packaging film for laundry products. The LL/LD/nylon components contain from about 10 to 100% bio-based content.

### Example #52

A film of the following structural composition: 15 micron nylon/Reverse print layer/adhesive/140 micron LL & LDPE. The film is used as a packaging film for laundry products. The LL/LD/nylon components contain from about 10 to 100% bio-based content.

### Example #53

A film of the following structural composition: 15 micron nylon/Reverse print layer/adhesive/150 micron LL & LDPE. The film is used as a packaging film for laundry products. The LL/LD/nylon components contain from about 10 to 100% bio-based content.

### Example #54

A film of the following structural composition: 20 micron BOPP/Reverse print layer/adhesive/50 micron LL & LDPE. The film is used as a packaging film for consumer care products. The LL/LD/BOPP components contain from about 10 to 100% bio-based content.

### Example #55

A film of the following structural composition: 20 micron BOPP/Reverse print layer/adhesive/60 micron LL & LDPE. The film is used as a packaging film for consumer care products. The LL/LD/BOPP components contain from about 10 to 100% bio-based content.

### Example #56

A film of the following structural composition: 20 micron BOPP/Reverse print layer/adhesive/70 micron LL & LDPE. The film is used as a packaging film for consumer care products. The LL/LD/BOPP components contain from about 10 to 100% bio-based content.

### Example #57

A film of the following structural composition: 20 micron BOPP/Reverse print layer/adhesive/80 micron LL & LDPE. The film is used as a packaging film for consumer care products. The LL/LD/BOPP components contain from about 10 to 100% bio-based content.

### Example #58

A film of the following structural composition: 20 micron BOPP/Reverse print layer/adhesive/100 micron LL & LDPE. The film is used as a packaging film for consumer care products. The LL/LD/BOPP components contain from about 10 to 100% bio-based content.

### Example #59

A film of the following structural composition: 20 micron BOPP/Reverse print layer/adhesive/130 micron LL & LDPE. The film is used as a packaging film for consumer care products. The LL/LD/BOPP components contain from about 10 to 100% bio-based content.

### Example #60

A film of the following structural composition: 20 micron BOPP/Reverse print layer/adhesive/140 micron LL & LDPE. The film is used as a packaging film for consumer care products. The LL/LD/BOPP components contain from about 10 to 100% bio-based content.

### Example #61

A film of the following structural composition: 20 micron BOPP/Reverse print layer/adhesive/150 micron LL & LDPE. The film is used as a packaging film for consumer care products. The LL/LD/BOPP components contain from about 10 to 100% bio-based content.

### Example #62

A film of the following structural composition: 20 micron BOPP/Reverse print layer/adhesive/20 micron BOPP. The film is used as a packaging film for consumer care products. The BOPP components contain from about 10 to 100% bio-based content.

### Example #63

A film of the following structural composition: 20 micron BOPP/Reverse print layer/adhesive/25 micron BOPP. The film is used as a packaging film for consumer care products. The BOPP components contain from about 10 to 100% bio-based content.

### Example #64

A film of the following structural composition: 20 micron BOPP/Reverse print layer/adhesive/35 micron BOPP. The film is used as a packaging film for consumer care products. The BOPP components contain from about 10 to 100% bio-based content.

### Example #65

A film of the following structural composition: Laquer/Print Layer/18 micron BOPP/30 micron LL & LDPE cold seal coating. The film is used as a packaging film for consumer products. The LL & LDPE/BOPP components contain from about 10 to 100% bio-based content.

### Example #66

A film of the following structural composition: 23 micron PET/Reverse Print/Adhesive/7 micron Aluminum/adhesive/25 micron LL & LDPE. The film is used as a packaging film for consumer products. The PET/LL & LDPE components contain from about 10 to 100% bio-based content.

### Example #67

A film of the following structural composition: 12 micron PET/Reverse Print/Adhesive/9 micron Aluminum/adhesive/30 micron LL & LDPE. The film is used as a packaging film for consumer products. The PET/LL & LDPE components contain from about 10 to 100% bio-based content.

### Example #68

A film of the following structural composition: 12 micron PET/Reverse Print/Adhesive/9 micron Aluminum/adhesive/35 micron Barex. The film is used as a packaging film for consumer products. The PET/Barex components contain from about 10 to 100% bio-based content.

### Example #69

A film of the following structural composition: 12 micron PET/Reverse Print/Adhesive/9 micron Aluminum/adhesive/20 micron BOPP. The film is used as a packaging film for consumer products. The PET/BOPP components contain from about 10 to 100% bio-based content.

### Example #70

A film of the following structural composition: 12 micron PET/Reverse Print/Adhesive/7 micron Aluminum/adhesive/25 micron LL & LDPE. The film is used as a packaging film for consumer products. The PET/LL & LDPE components contain from about 10 to 100% bio-based content.

### Example #71

A film of the following structural composition: 12 micron PET/Reverse Print/Adhesive/7 micron Aluminum/adhesive/30 micron LL & LDPE. The film is used as a packaging film for consumer products. The PET/LL & LDPE components contain from about 10 to 100% bio-based content.

### Example #72

A film of the following structural composition: 12 micron PET/Reverse Print/Adhesive/7 micron Aluminum/adhesive/38 micron LL & LDPE. The film is used as a packaging film for consumer products. The PET/LL & LDPE components contain from about 10 to 100% bio-based content.

### Example #73

A film of the following structural composition: 12 micron PET/Reverse Print/Adhesive/7 micron Aluminum/adhesive/50 micron LL & LDPE. The film is used as a packaging film for consumer products. The PET/LL & LDPE components contain from about 10 to 100% bio-based content.

### Example #74

A film of the following structural composition: 12 micron PET/Reverse Print/Adhesive/7 micron Aluminum/adhesive/60 micron LL & LDPE. The film is used as a packaging film for consumer products. The PET/LL & LDPE components contain from about 10 to 100% bio-based content.

### Example #75

A film of the following structural composition: 12 micron PET/Reverse Print/Adhesive/7 micron Aluminum/adhesive/80 micron peel seal. The film is used as a packaging film for consumer products. The PET/LL & LDPE components contain from about 10 to 100% bio-based content.

### Example #76

A film of the following structural composition: 12 micron PET/Reverse Print/Adhesive/7 micron Aluminum/adhesive/80 micron LL & LDPE. The film is used as a packaging film for consumer products. The PET/LL & LDPE components contain from about 10 to 100% bio-based content.

### Tri-Layer Films

### Example #77

A symmetrical tri-layer film of ABA construction is 15 microns in thickness. Skin layer A is 3 microns in thickness and is LL & LDPE. Core layer B is 9 micron thick and composed of HDPE. The film is printed and used as an overwrap for consumer paper products.

### Example #78

A symmetrical tri-layer film of ABA construction is 18 microns in thickness. Skin layer A is 3 microns in thickness and is LL & LDPE. Core layer B is 12 micron thick and composed of HDPE. The film is printed and used as an overwrap for consumer paper products.

### Example #79

A symmetrical tri-layer film of ABA construction is 20 microns in thickness. Skin layer A is 4 microns in thickness and is LL & LDPE. Core layer B is 12 micron thick and composed of HDPE. The film is printed and used as an overwrap for consumer paper products.

### Example #80

A symmetrical tri-layer film of ABA construction is 23 microns in thickness. Skin layer A is 4 microns in thickness and is LL & LDPE. Core layer B is 15 micron thick and composed of HDPE. The film is printed and used as an overwrap for consumer paper products.

### Example #81

A symmetrical tri-layer film of ABA construction is 38 microns in thickness.

Skin layer A is 8 microns in thickness and is metalocene LLDPE. Core layer B is 22 micron thick and composed of LLDPE. The film is printed and used as an overwrap for consumer paper products.

### Example #82

A symmetrical tri-layer film of ABA construction is 70 microns in thickness. Skin layer A is 10 microns in thickness and is LL & LDPE. Core layer B is 50 micron thick and composed of LLDPE/HDPE/LDPE. Core layer B contains 1% TiO2. The film is printed and used as a bag material in flexible packaging.

### Example #83

A symmetrical tri-layer film of ABA construction is 50 microns in thickness. Skin layer A is 8 microns in thickness and is LL & LDPE. Core layer B is 34 micron thick and composed of LLDPE/HDPE/LDPE. Core layer B contains 1% TiO2. The film is printed and used as a bag material in flexible packaging.

### Example #84

A symmetrical tri-layer film of ABA construction is 40 microns in thickness. Skin layer A is 5 microns in thickness and is LL & LDPE. Core layer B is 30 micron thick and composed of LLDPE/HDPE/LDPE. Core layer B contains 1% TiO2. The film is printed and used as a bag material in flexible packaging.

### Example #85

A symmetrical tri-layer film of ABA construction is 27 microns in thickness. Skin layer A is 3.75 microns in thickness and is LL & LDPE. Core layer B is 19.5 microns thick and composed of LLDPE/LDPE. Core layer B contains 4% TiO2 and 1% surfactant. The film is hydroformed to produce a 3-D expanded fluid functional film for use in feminine hygiene products.

### Example #86

A symmetrical tri-layer film of ABA construction is 18 microns in thickness. Skin layer A is 3 microns in thickness and is LL & LDPE. Core layer B is 12 microns thick and composed of LLDPE/LDPE/MDPE/HDPE. Core layer B contains 4% colorant. The film is used as a wrapper in feminine hygiene products.

### Example #87

A symmetrical tri-layer film of ABA construction is 16 microns in thickness. Skin layer A is 3 microns in thickness and is LL & LDPE. Core layer B is 10 microns thick and composed of LLDPE/LDPE/MDPE/HDPE/PP/coPP. Core layer B contains 4% colorant. The film is used as a backsheet in hygiene products.

### Example #88

A symmetrical tri-layer film of ABA construction is 40 microns in thickness.

Skin layer A is 5 microns in thickness and is LL & LDPE. Core layer B is 30 microns thick and composed of Kraton-G TPE. Core layer B contains 1% colorant. The film is vacuum formed to add apertures to the structure. The film is used as an elastic stretch engine in hygiene products.

### Example #89

A symmetrical tri-layer film of ABA construction is 30 microns in thickness. Skin layer A is 3 microns in thickness and is LL & LDPE. Core layer B is 24 microns thick and composed of Kraton-G TPE. Core layer B contains 1% colorant. The film is used as an elastic stretch engine in hygiene products.

### Example #90

A symmetrical tri-layer film of ABA construction is 30 microns in thickness. Skin layer A is 3 microns in thickness and is LL & LDPE. Core layer B is 24 microns thick and composed of Kraton-G TPE. Core layer B contains 1% colorant. The film is used as an elastic stretch engine in hygiene products.

### Example #91

A film of the following structural composition: 12 micron PET/Reverse Print/Exl LDPE/30 micron LL & LDPE. The film is used as a packaging film for consumer products. The PET/LL & LDPE components contain from about 10 to 100% bio-based content.

### Example #92

A film of the following structural composition: 12 micron PET/Reverse Print/Exl LDPE/38 micron LL & LDPE. The film is used as a packaging film for consumer products. The PET/LL & LDPE components contain from about 10 to 100% bio-based content.

### Example #93

A film of the following structural composition: 12 micron PET/Reverse Print/Exl LDPE/50 micron LL & LDPE. The film is used as a packaging film for consumer products. The PET/LL & LDPE components contain from about 10 to 100% bio-based content.

### Example #94

A film of the following structural composition: 12 micron PET/Reverse Print/Exl LDPE/60 micron LL & LDPE. The film is used as a packaging film for consumer products. The PET/LL & LDPE components contain from about 10 to 100% bio-based content.

### Example #95

A film of the following structural composition: 12 micron PET/Reverse Print/Exl LDPE/90 micron LL & LDPE. The film is used as a packaging film for bags utilized in consumer products. The PET/LL & LDPE components contain from about 10 to 100% bio-based content.

### Example #96

A film of the following structural composition: 12 micron PET/Reverse Print/Adhesive/120 micron white OPP/Reverse Print/Adhesive/100 micron PET. The film is used as a packaging film for consumer products. The PET/LL & LDPE/OPP components contain from about 10 to 100% bio-based content.

### Example #97

A film of the following structural composition: 40 micron LL/LDPE/12 micron PET/60 micron LL & LDPE. The film is used as a packaging film for consumer products. The PET/LL & LDPE components contain from about 10 to 100% bio-based content.

### Example #98

A film of the following structural composition: 40 micron LL/LDPE/12 micron PET/80 micron LL & LDPE. The film is used as a packaging film for consumer products. The PET/LL & LDPE components contain from about 10 to 100% bio-based content.

### Example #99

A film of the following structural composition: 20 micron OPP/Reverse print/Adhesive/45 gsm paper/12 micron Exc LDPE. The film is used as a packaging film for consumer products. The OPP/LL & LDPE components contain from about 10 to 100% bio-based content.

### Example #100

A film of the following structural composition: 12 micron PET/Reverse print/Adhesive/15 micron nylon/adhesive/80 micron LL & LDPE. The film is used as a packaging film for consumer products. The PET/nylon/LL & LDPE components contain from about 10 to 100% bio-based content.

### Example #101

A film of the following structural composition: 12 micron PET/Reverse print/Adhesive/15 micron nylon/adhesive/60 micron LL & LDPE. The film is used as a packaging film for consumer products. The PET/nylon/LL & LDPE components contain from about 10 to 100% bio-based content.

### Example #102

A film of the following structural composition: 12 micron PET/Reverse print/Adhesive/15 micron nylon/adhesive/130 micron LL & LDPE. The film is used as a packaging film for consumer products. The PET/nylon/LL & LDPE components contain from about 10 to 100% bio-based content.

### Example #103

A film of the following structural composition: 12 micron PET/Reverse print/Adhesive/12 micron PET/adhesive/50 micron LL & LDPE. The film is used as a packaging film for consumer products. The PET/LL & LDPE components contain from about 10 to 100% bio-based content.

### Example #104

A film of the following structural composition: 12 micron PET/Reverse print/Adhesive/12 micron PET/adhesive/70 micron LL & LDPE. The film is used as a packaging film for consumer products. The PET/LL & LDPE components contain from about 10 to 100% bio-based content.

### Example #105

A film of the following structural composition: 12 micron PET/Reverse print/Adhesive/12 micron PET/adhesive/eazy open 80 micron LL & LDPE. The film is used as a packaging film for consumer products. The PET/nylon/LL & LDPE components contain from about 10 to 100% bio-based content.

### Example #106

A film of the following structural composition: 12 micron PET/Reverse print/Adhesive/12 micron PET/adhesive/100 micron LL & LDPE. The film is used as a packaging film for consumer products. The PET/LL & LDPE components contain from about 10 to 100% bio-based content.

### Example #107

A film of the following structural composition: 12 micron PET/Reverse print/Adhesive/12 micron PET/adhesive/90 micron HDPE/LL & LDPE. The film is used as a packaging film for consumer products. The PET/LL & LDPE/HDPE components contain from about 10 to 100% bio-based content.

### Example #108

A film of the following structural composition: 15 micron nylon/Reverse print/Adhesive/12 micron PET/adhesive/50 micron LL & LDPE. The film is used as a packaging film for consumer products. The nylon/PET/LL & LDPE components contain from about 10 to 100% bio-based content.

### Example #109

A film of the following structural composition: 15 micron nylon/Reverse print/Adhesive/12 micron PET/adhesive/70 micron LL & LDPE. The film is used as a packaging film for consumer products. The nylon/PET/LL & LDPE components contain from about 10 to 100% bio-based content.

### Example #110

A film of the following structural composition: 15 micron nylon/Reverse print/Adhesive/12 micron PET/adhesive/eazy open 80 micron LL & LDPE. The film is used as a packaging film for consumer products. The PET/nylon/LL & LDPE components contain from about 10 to 100% bio-based content.

### Example #111

A film of the following structural composition: 15 micron nylon/Reverse print/Adhesive/12 micron PET/adhesive/100 micron LL & LDPE. The film is used as a packaging film for consumer products. The nylon/PET/LL & LDPE components contain from about 10 to 100% bio-based content.

### Example #112

A film of the following structural composition: 15 micron nylon/Reverse print/Adhesive/12 micron PET/adhesive/90 micron nylon/HDPE/LL & LDPE. The film is used as a packaging film for consumer products. The nylon/PET/LL & LDPE/HDPE components contain from about 10 to 100% bio-based content.

### Example #113

A film of the following structural composition: 12 micron PET/Reverse print/Adhesive/18 micron BOPP/adhesive/30 micron LL & LDPE. The film is used as a packaging film for consumer products. The PET/BOPP/LL & LDPE components contain from about 10 to 100% bio-based content.

### Example #114

A film of the following structural composition: 12 micron PET/Reverse print/Adhesive/18 micron BOPP/adhesive/38 micron LL & LDPE. The film is used as a packaging film for consumer products. The PET/BOPP/LL & LDPE components contain from about 10 to 100% bio-based content.

### Example #115

A film of the following structural composition: 12 micron PET/Reverse print/Adhesive/18 micron BOPP/adhesive/50 micron LL & LDPE. The film is used as a packaging film for consumer products. The PET/BOPP/LL & LDPE components contain from about 10 to 100% bio-based content.

### Example #116

A film of the following structural composition: 12 micron PET/Reverse print/Adhesive/18 micron BOPP/adhesive/80 micron LL & LDPE. The film is used as a packaging film for consumer products. The PET/BOPP/LL & LDPE components contain from about 10 to 100% bio-based content.

### Example #117

A film of the following structural composition: 10 micron PET/Reverse print/Adhesive/18 micron BOPP/adhesive/30 micron LL & LDPE. The film is used as a packaging film for consumer products. The PET/BOPP/LL & LDPE components contain from about 10 to 100% bio-based content.

### Example #118

A film of the following structural composition: 10 micron PET/Reverse print/Adhesive/18 micron BOPP/adhesive/38 micron LL & LDPE. The film is used as a packaging film for consumer products. The PET/BOPP/LL & LDPE components contain from about 10 to 100% bio-based content.

### Example #119

A film of the following structural composition: 10 micron PET/Reverse print/Adhesive/18 micron BOPP/adhesive/50 micron LL & LDPE. The film is used as a packaging film for consumer products. The PET/BOPP/LL & LDPE components contain from about 10 to 100% bio-based content.

### Example #120

A film of the following structural composition: 10 micron PET/Reverse print/Adhesive/18 micron BOPP/adhesive/80 micron LL & LDPE. The film is used as a packaging film for consumer products. The PET/BOPP/LL & LDPE components contain from about 10 to 100% bio-based content.

### Example #121

A film of the following structural composition: 12 micron PET/Reverse print/Adhesive/9 micron foil/adhesive/12 micron PET/adh/55 micron LL & LDPE. The film is used as a packaging film for consumer products. The PET//LL & LDPE components contain from about 10 to 100% bio-based content.

### Example #122

A film of the following structural composition: 12 micron PET/Reverse print/Adhesive/7 micron foil/adhesive/12 micron PET/adh/50 micron LL & LDPE. The film is used as a packaging film for consumer products. The PET//LL & LDPE components contain from about 10 to 100% bio-based content.

### Example #123

A film of the following structural composition: 12 micron PET/Reverse print/Adhesive/7 micron foil/adhesive/12 micron PET/adh/70 micron LL & LDPE. The film is used as a packaging film for consumer products. The PET//LL & LDPE components contain from 10 to 100% bio-based content.

### Example #124

A film of the following structural composition: 12 micron PET/Reverse print/Adhesive/7 micron foil/adhesive/12 micron PET/adh/100 micron LL & LDPE. The film is used as a packaging film for consumer products. The PET//LL & LDPE components contain from about 10 to 100% bio-based content.

### Example #125

A film of the following structural composition: 12 micron PET/Reverse print/Adhesive/7 micron foil/adhesive/15 micron nylon/adh/100 micron LL & LDPE. The film is used as a packaging film for consumer products. The nylon/PET//LL & LDPE components contain from about 10 to 100% bio-based content.

### Example #125

A film of the following structural composition: 12 micron PET/Reverse print/ExL LDPE/7 micron foil/adhesive/38 micron Barex. The film is used as a packaging film for consumer products. The PET//LL & LDPE/Barex components contain from about 10 to 100% bio-based content.

### Four-Layer Films

### Example #126

A film of the following structural composition: 12 micron PET/Reverse print/ExL LDPE/12 micron BOPP/25 micron LL & LDPE. The film is used as a packaging film for consumer products. The PET//LL & LDPE/BOPP components contain from about 10 to 100% bio-based content.

### Example #127

A film of the following structural composition: 12 micron PET/Reverse print/ExL LDPE/12 micron BOPP/38 micron LL & LDPE. The film is used as a packaging film for consumer products. The PET/LL & LDPE/BOPP components contain from about 10 to 100% bio-based content.

### Example #128

A film of the following structural composition: 12 micron PET/Reverse print/ExL LDPE/7 micron aluminum/LDPE/30 micron LL & LDPE. The film is used as a packaging film for consumer products. The PET//LL & LDPE components contain from about 10 to 100% bio-based content.

### Five-Layer Films

### Example #129

A film of the following structural composition: 25 micron LL&LDPE/LDPE/12 micron PET/LDPE/60 micron LL&LDPE. The film is used as a packaging film for consumer products. The LL&LDPE/PET components contain from about 10 to 100% bio-based content.

### Example #130

A film of the following structural composition: 25 micron LL&LDPE/LDPE/12 micron PET/LDPE/70 micron LL&LDPE. The film is used as a packaging film for consumer products. The LL&LDPE/PET components contain from about 10 to 100% bio-based content.

### Example #131

A film of the following structural composition: 25 micron LL&LDPE/LDPE/12 micron PET/LDPE/80 micron LL&LDPE. The film is used as a packaging film for consumer products. The LL&LDPE/PET components contain from about 10 to 100% bio-based content.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A high bio-content monolayer film comprising a blend of LDPE and LLDPE with a thickness equal to 25 μm and a bio-based content of at least 80%.

2. A high bio-content bi-layer film comprising synthetic polymers with a thickness of from about 1 μm to about 750 μm and a biobased content of at least about 80%.

3. The high bio-content bi-layer film of claim 2 wherein said synthetic polymers have a thickness of from about 1 μm to about 200 μm.

4. A high bio-content bi-layer film of claim 1 further comprising post-consumer recycled polymers.

5. A high bio-content multi-layer film comprising polymers selected from the group consisting of:
1) synthetic polymers;
2) polymers derived from natural resources; and
3) post-consumer recycled polymers
with a thickness of about 1 μm to about 200 μm and a biobased content of at least about 80%.

6. The high bio-content multi-layer film of claim 5 wherein the film has three layers.

7. The high bio-content multi-layer film of claim 5 wherein the film has four layers.

8. The high bio-content multi-layer film of claim 5 wherein the film has five layers.
